(19) United States
(12) Patent Application Publication
(10) Pub. No.: US 2025/0298731 A1
(43) Pub. Date: Sep. 25, 2025

(54) METHOD AND SYSTEM FOR EVALUATION OF CODE GENERATION BY LARGE LANGUAGE MODEL

(71) Applicant: JPMorgan Chase Bank, N.A., New York, NY (US)

(72) Inventors: Deepeka GARG, London (GB); Leo ARDON, London (GB); Mengda XU, Jersey City, NJ (US); Annapoorani LAKSHMI NARAYANAN, New York, NY (US); Yuchen XIAO, Jersey City, NJ (US); Jared VANN, London (GB); Udari MADHUSHANI, Jersey City, NJ (US); Sumitra GANESH, Short Hills, NJ (US)

(73) Assignee: JPMorgan Chase Bank, N.A., New York, NY (US)

(21) Appl. No.: 18/612,079

(22) Filed: Mar. 21, 2024

(51) Int. Cl. G06F 11/36; G06F 8/35

(52) U.S. Cl. CPC G06F 11/3692; G06F 8/35; G06F 11/3612; G06F 11/3688

(57) ABSTRACT

A method and a system for obtaining an evaluation of a quality of software code that is generated by using a large language model (LLM) are provided. The method includes: receiving a set of instructions for performing a task and generating an output; providing, as an input to an LLM, a list of available application programming interfaces (APIs) and the instructions, together with a submission of a request to the LLM to select one API and to generate a set of executable code based on the instructions; receiving, from the LLM, a selection of one API and the set of executable code; executing the set of executable code in order to perform the first task and generate the output; and evaluating an accuracy, a robustness, and/or a consistency of the set of executable code.

### BACKGROUND

### 1. Field of the Disclosure

This technology generally relates to methods and systems for evaluating a quality of software code, and more particularly to methods and systems for obtaining an evaluation of a quality of software code that is generated by using a large language model.

### 2. Background Information

The use of large language models (LLMs) has become widespread in recent years, as they often provide a very expeditious way to generate a desired output, such as a textual output or an image/pictorial output. One popular use for LLMs is to generate software code.

A potential downside of using an LLM is the fact that in some instances, the quality of an output may not be adequate. In addition, it may be difficult to ascertain whether or not the quality of the output is good. One of the significant challenges in evaluating code generated by LLMs lies in understanding the impact of prompt variations or changes in code generation methodologies. While adjustments to prompts are often made with the intention of improving code quality, it is not always straightforward to discern whether such modifications indeed contribute to enhancements or inadvertently lead to deteriorations along various dimensions such as accuracy, robustness, and efficiency.

In the case of using an LLM to generate code, the evaluation of such code remains an open research question. No standard exists to evaluate the quality of a response produced by an LLM. In settings where the output of the LLM can have serious effects, such as the execution of code generated by the LLM, it becomes crucial to have an effective mechanism to evaluate the LLM-based solution.

Accordingly, there is a need for a method for obtaining a systematic evaluation of a quality of software code that is generated by using an LLM.

### SUMMARY

The present disclosure, through one or more of its various aspects, embodiments, and/or specific features or sub-components, provides, inter alia, various systems, servers, devices, methods, media, programs, and platforms for obtaining an evaluation of a quality of software code that is generated by using an LLM.

According to an aspect of the present disclosure, a method for evaluating code quality is provided. The method is implemented by at least one processor. The method includes: receiving, by the at least one processor, a first set of instructions for performing a first task and generating a first output; providing, by the at least one processor as an input to a first LLM, a list of available application programming interfaces (APIs) and the first set of instructions, together with a submission of a request to the first LLM to select one API and to generate a first set of executable code based on the first set of instructions; receiving, by the at least one processor from the first LLM, a selection of the one API and the first set of executable code; executing, by the at least one processor, the first set of executable code in order to perform the first task and generate the first output; and evaluating, by the at least one processor, a quality of the first set of executable code.

The evaluating of the quality of the first set of executable code may include evaluating at least one from among an accuracy of the first set of executable code, a robustness of the first set of executable code, and a consistency of the first set of executable code.

The evaluating of the accuracy of the first set of executable code may include: checking whether the first set of executable code runs; checking whether the first set of executable code calls a correct API with correct parameters; and checking whether the first output matches with an expected output.

The evaluating of the robustness of the first set of executable code may include: determining a difficulty level of the first set of instructions; and assessing the selection of the one API and an ability to execute the first set of instructions based on the determined difficulty level.

The determining of the difficulty level may include determining a degree of implicitness of information included in the first set of instructions with respect to the first task.

The evaluating of the consistency of the first set of executable code may include: testing results of the executing of the first set of executable code across multiple runs; and determining whether the results provide different answers for a same input.

The testing of the results may be performed for at least three runs and for at most ten runs.

The evaluating of the quality of the first set of executable code may be performed by using an evaluation dataset that is API-based and corresponds to single-step instructions and/or multi-step instructions.

According to another exemplary embodiment, a computing apparatus for evaluating code quality is provided. The computing apparatus includes a processor; a memory; and a communication interface coupled to each of the processor and the memory. The processor is configured to: receive, via the communication interface, a first set of instructions for performing a first task and generating a first output; provide, as an input to a first LLM, a list of available APIs and the first set of instructions, together with a submission of a request to the first LLM to select one API and to generate a first set of executable code based on the first set of instructions; receive, from the first LLM, a selection of the one API and the first set of executable code; execute the first set of executable code in order to perform the first task and generate the first output; and evaluate a quality of the first set of executable code.

The processor may be further configured to evaluate the quality of the first set of executable code by performing at least one from among an evaluation of an accuracy of the first set of executable code, an evaluation of a robustness of the first set of executable code, and an evaluation of a consistency of the first set of executable code.

The processor may be further configured to perform the evaluation of the accuracy of the first set of executable code by: checking whether the first set of executable code runs; checking whether the first set of executable code calls a correct API with correct parameters; and checking whether the first output matches with an expected output.

The processor may be further configured to perform the evaluation of the robustness of the first set of executable code by: determining a difficulty level of the first set of instructions; and assessing the selection of the one API and an ability to execute the first set of instructions based on the determined difficulty level.

The processor may be further configured to make the determination of the difficulty level by determining a degree of implicitness of information included in the first set of instructions with respect to the first task.

The processor may be further configured to perform the evaluation of the consistency of the first set of executable code by: testing results of the executing of the first set of executable code across multiple runs; and determining whether the results provide different answers for a same input.

The testing of the results may be performed for at least three runs and for at most ten runs.

The processor may be further configured to evaluate the quality of the first set of executable code by using an evaluation dataset that is API-based and corresponds to single-step instructions and/or multi-step instructions.

According to yet another exemplary embodiment, a non-transitory computer readable storage medium storing instructions for evaluating code quality is provided. The storage medium includes a first set of executable code which, when executed by a processor, causes the processor to: receive a first set of instructions for performing a first task and generating a first output; provide, as an input to a first LLM, a list of available APIs and the first set of instructions, together with a submission of a request to the first LLM to select one API and to generate a second set of executable code based on the first set of instructions; receive, from the first LLM, a selection of the one API and the second set of executable code; execute the second set of executable code in order to perform the first task and generate the first output; and evaluate a quality of the second set of executable code.

When executed by the processor, the first set of executable code may further cause the processor to evaluate the quality of the second set of executable code by evaluating at least one from among an accuracy of the second set of executable code, a robustness of the second set of executable code, and a consistency of the second set of executable code.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for obtaining an evaluation of a quality of software code that is generated by using an LLM.

FIG. 4 is a flowchart of an exemplary process for implementing a method for obtaining an evaluation of a quality of software code that is generated by using an LLM.

FIG. 5 is an illustration of evaluation dataset task dimensions as implemented in a system for obtaining an evaluation of a quality of software code that is generated by using an LLM, according to an exemplary embodiment.

FIG. 6 is an illustration of types of task variations with a representative example as implemented in a system for obtaining an evaluation of a quality of software code that is generated by using an LLM, according to an exemplary embodiment.

FIG. 7 is an illustration of types of application programming interface (API) variations with a representative example as implemented in a system for obtaining an evaluation of a quality of software code that is generated by using an LLM, according to an exemplary embodiment.

FIG. 8 is an illustration of a prompt for an API-based multi-step task generation operation as implemented in a system for obtaining an evaluation of a quality of software code that is generated by using an LLM, according to an exemplary embodiment.

FIG. 9 is an illustration of an evaluation pipeline as implemented in a system for obtaining an evaluation of a quality of software code that is generated by using an LLM, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

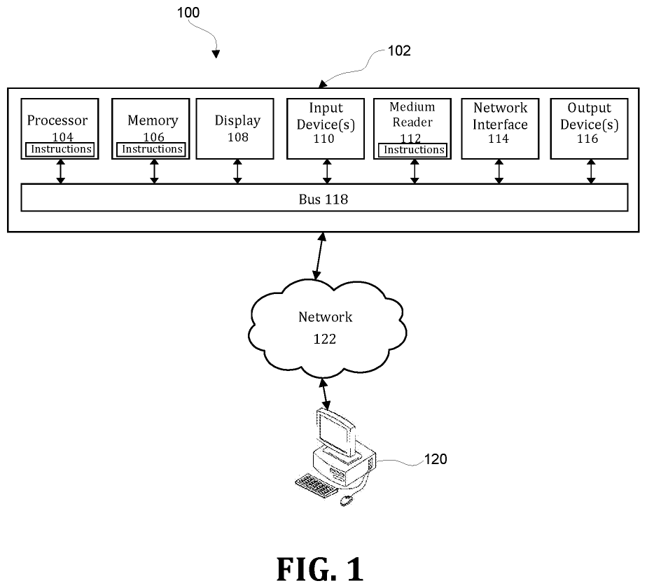

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for obtaining an evaluation of a quality of software code that is generated by using an LLM.

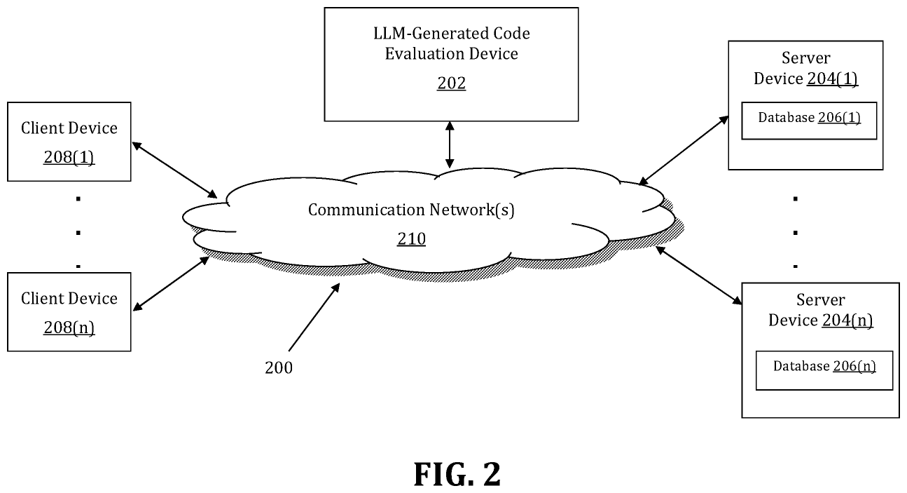

Referring to FIG. 2, a schematic of an exemplary network environment 200 for implementing a method for obtaining an evaluation of a quality of software code that is generated by using an LLM is illustrated. In an exemplary embodiment, the method is executable on any networked computer platform, such as, for example, a personal computer (PC).

The method for obtaining an evaluation of a quality of software code that is generated by using an LLM may be implemented by an LLM-Generated Code Evaluation (LGCE) device 202. The LGCE device 202 may be the same or similar to the computer system 102 as described with respect to FIG. 1. The LGCE device 202 may store one or more applications that can include executable instructions that, when executed by the LGCE device 202, cause the LGCE device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the LGCE device 202 itself, may be located in virtual server(s) running in a cloud-based computing environment rather than being tied to one or more specific physical network computing devices. Also, the application(s) may be running in one or more virtual machines (VMs) executing on the LGCE device 202. Additionally, in one or more embodiments of this technology, virtual machine(s) running on the LGCE device 202 may be managed or supervised by a hypervisor.

In the network environment 200 of FIG. 2, the LGCE device 202 is coupled to a plurality of server devices 204(1)-204(n) that hosts a plurality of databases 206 (1)-206(n), and also to a plurality of client devices 208 (1)-208(n) via communication network(s) 210. A communication interface of the LGCE device 202, such as the network interface 114 of the computer system 102 of FIG. 1, operatively couples and communicates between the LGCE device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the LGCE device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and LGCE devices that efficiently implement a method for obtaining an evaluation of a quality of software code that is generated by using an LLM.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The LGCE device 202 may be a standalone device or integrated with one or more other devices or apparatuses, such as one or more of the server devices 204(1)-204(n), for example. In one particular example, the LGCE device 202 may include or be hosted by one of the server devices 204(1)-204(n), and other arrangements are also possible. Moreover, one or more of the devices of the LGCE device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the LGCE device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information that relates to LLM-generated code and information that relates to quality metrics for evaluation of code.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the LGCE device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the LGCE device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the LGCE device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the LGCE device 202, the server devices 204(1)-204(n), or the client devices 208(1)-208(n), for example, may be configured to operate as virtual instances on the same physical machine. In other words, one or more of the LGCE device 202, the server devices 204(1)-204(n), or the client devices 208(1)-208(n) may operate on the same physical device rather than as separate devices communicating through communication network(s) 210. Additionally, there may be more or fewer LGCE devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

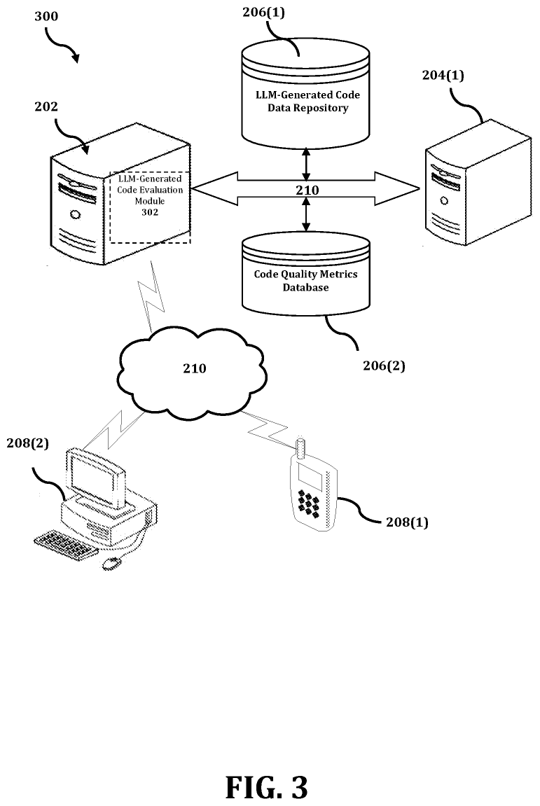

The LGCE device 202 is described and illustrated in FIG. 3 as including an LLM-generated code evaluation module 302, although it may include other rules, policies, modules, databases, or applications, for example. As will be described below, the LLM-generated code evaluation module 302 is configured to implement a method for obtaining an evaluation of a quality of software code that is generated by using an LLM.

An exemplary process 300 for implementing a mechanism for obtaining an evaluation of a quality of software code that is generated by using an LLM by utilizing the network environment of FIG. 2 is illustrated as being executed in FIG. 3. Specifically, a first client device 208(1) and a second client device 208(2) are illustrated as being in communication with LGCE device 202. In this regard, the first client device 208(1) and the second client device 208(2) may be “clients” of the LGCE device 202 and are described herein as such. Nevertheless, it is to be known and understood that the first client device 208(1) and/or the second client device 208(2) need not necessarily be “clients” of the LGCE device 202, or any entity described in association therewith herein. Any additional or alternative relationship may exist between either or both of the first client device 208(1) and the second client device 208(2) and the LGCE device 202, or no relationship may exist.

Further, LGCE device 202 is illustrated as being able to access an LLM-generated code data repository 206(1) and a code quality metrics database 206(2). The LLM-generated code evaluation module 302 may be configured to access these databases for implementing a method for obtaining an evaluation of a quality of software code that is generated by using an LLM.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the LGCE device 202 via broadband or cellular communication. Of course, these embodiments are merely exemplary and are not limiting or exhaustive.

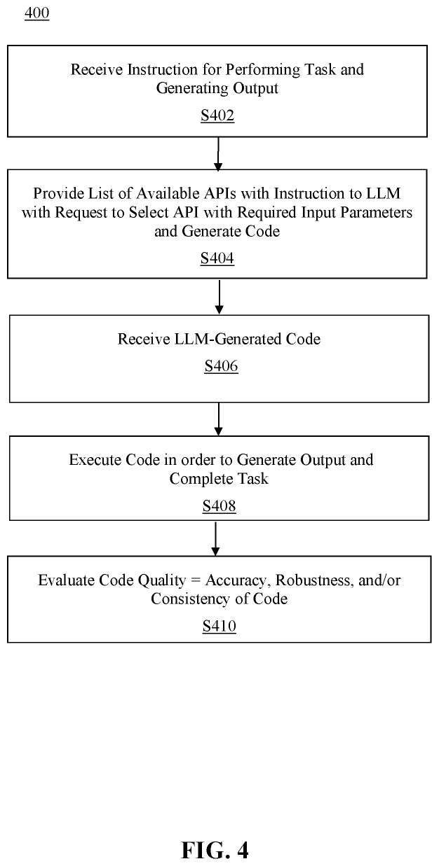

Upon being started, the LLM-generated code evaluation module 302 executes a process for obtaining an evaluation of a quality of software code that is generated by using an LLM. An exemplary process for obtaining an evaluation of a quality of software code that is generated by using an LLM is generally indicated at flowchart 400 in FIG. 4.

In process 400 of FIG. 4, at step S402, the LLM-generated code evaluation module 302 receives a first set of instructions for performing a particular task and for generating an output. Then, at step S404, the LLM-generated code evaluation module 302 provides an input to an LLM that includes a list of available application programming interfaces (APIs) and the first set of instructions, together with a submission of a request to select one API from the list, together with a set of required input parameters, and to generate a set of executable code that is responsive to the first set of instructions.

At step S406, the LLM-generated code evaluation module 302 receives a selection of an API with the set of required input parameters and the requested set of executable code from the LLM. Then, at step S408, the LLM-generated code evaluation module 302 executes the code, in order to perform the task and also to generate the output.

At step S410, the LLM-generated code evaluation module 302 uses a result of the execution of the code in step S408 to evaluate a quality of the code. In an exemplary embodiment, the evaluation of the code quality includes any one or more of an evaluation of an accuracy of the code, an evaluation of a robustness of the code, and/or an evaluation of a consistency of the code. The evaluation of the code quality may be performed by using an API-based data set that corresponds to single-step instructions and/or multi-step instructions.

In an exemplary embodiment, the evaluation of the accuracy of the code includes the following steps. The first step is to check whether the code runs properly. The second step is to check whether the code calls a correct API with correct parameters associated therewith. The third step is to check whether the output that is generated by executing the code matches with an expected output.

In an exemplary embodiment, the evaluation of the robustness of the code includes the following. First, a determination of a difficulty level of the first set of instructions is made. Second, an assessment of the selection of the API from among of set of APIs having varying degrees of complexity and an ability to execute the first set of instructions based on the determined difficulty level is made. In an exemplary embodiment, the determination of the difficulty level is performed by determining a degree of implicitness of the information included in the first set of instructions with respect to the task to be performed. The difficulty level may be assigned as being either a relatively low difficulty level, a relatively high difficulty level, or a medium difficulty level that is in between the low and high difficulty levels.

In an exemplary embodiment, the evaluation of the consistency of the code includes two steps. First, a test of results of executing the code across multiple runs is performed. Second, a determination is made as to whether the results provide different answers for the same inputs, or whether providing the same inputs consistently returns the same answers. In an exemplary embodiment, the number of runs used for testing results for consistency may be in a range of at least three runs and at most ten runs, such as, for example, five runs.

In an exemplary embodiment, the methodology developed to evaluate the proposed approach is based on a strategy to evaluate each of the accuracy, the robustness, and the consistency of the solution on multiple dimensions. In this aspect, the solution can be decomposed into two phases: the skill distillation phase, i.e., generating the tools or functions required to perform a task; and the execution phase, i.e., calling these functions to actually perform the task.

The skill distillation phase takes as an input an instruction and a set of available APIs and requires the LLM agent to 1) select the appropriate API to call, 2) generate code that calls this API with the right input parameters, and 3) generate code to parse the output from the API response. The execution phase takes, as an input, the code generated from the skill distillation phase, and then simply executes this code.

In an exemplary embodiment, the first dimension to be evaluated is the accuracy of the code generated, i.e., making sure that the code runs, calls the right API with the right parameters, and produces the expected output. The second dimension is the robustness with respect to different difficulty levels of instruction; indeed, an instruction can be more or less detailed, thereby adding an extra level of complexity to the task. In a similar fashion, the set of APIs to choose from can be challenging, depending on how similar these APIs are. Therefore, an evaluation of the ability to select the correct API from a set with different levels of complexity is also made. Finally, an evaluation of the consistency of the code generated is also made. LLMs are known to sometimes produce different answers for the same input. Accordingly, a test has been devised in order to evaluate how consistent the results are across multiple runs.

In an exemplary embodiment, the evaluation dataset is divided into three subsets: a first dataset that relates to instructions, a second dataset that relates to APIs, and a third dataset that relates to evaluation records. The instructions dataset contains all the original instructions that can be used during the evaluation and their variations, which may be characterized as belonging to one of three categories, i.e., easy, medium, and hard. The APIs dataset contains the original APIs definition that can be used and their associated variations that will be included into the set of APIs to choose from. Finally, the evaluation records dataset includes the set of test cases one can run. The evaluation records dataset references an instruction record from the instructions dataset and an API record from the APIs dataset, and contains an expected set of parameters to be used and an expected output. Each record is also labeled with a set of categories to help further categorize the results.

In an exemplary embodiment, for robust assessment of the proposed automation methodology, the evaluation dataset is generated along various dimensions to encompass a diverse set of evaluation tasks and their corresponding ground truths. Different input and output combinations, such as zero-input, single-output, and zero-input with multiple outputs, etc., have been incorporated. This deliberate variation aims to assess the robustness of the proposed methodology with respect to an LLM-based skill distillation agent by exposing it to a spectrum of task scenarios, in order to ensure its adaptability and effectiveness across a wide range of input-output configurations.

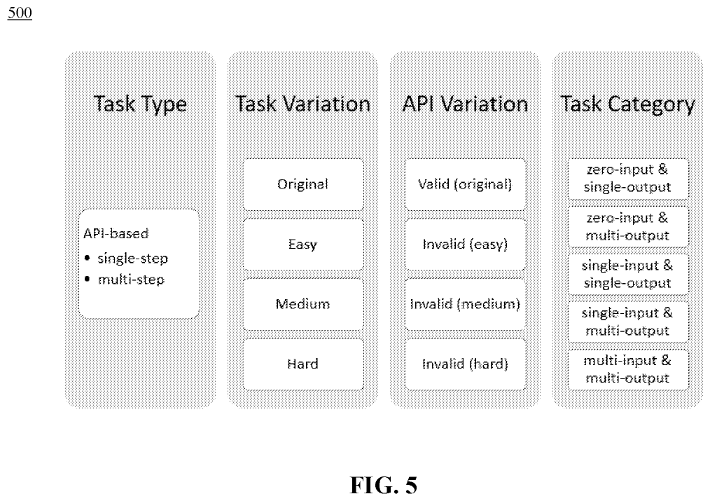

In an exemplary embodiment, the evaluation dataset encompasses API-based tasks. API-based tasks are formulated around use of available APIs involving making specific API calls, and the skill distillation agent is required to analyze and interpret the responses. Within this category, tasks are further diversified into single-step and multi-step variations. Single-step tasks involve execution of a single instruction or API call. In contrast, multi-step tasks introduce complexity by requiring the use of the output of one API call as the input for subsequent API calls, simulating more intricate task scenarios. In multi-step API-based tasks, the skill distillation agent is challenged to understand and navigate through a sequence of interconnected steps. This categorization provides a holistic evaluation by testing not only the agent's ability to handle individual API calls but also its capacity to comprehend and solve multi-step, interconnected tasks. FIG. 5 is an illustration 500 of evaluation dataset task dimensions as implemented in a system for obtaining an evaluation of a quality of software code that is generated by using an LLM, according to an exemplary embodiment.

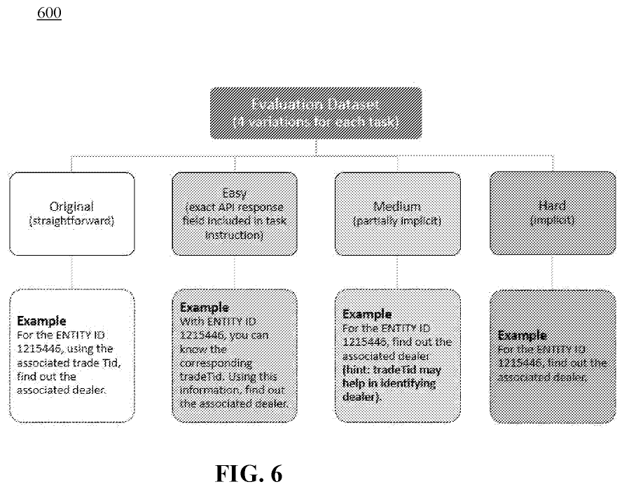

FIG. 6 is an illustration 600 of types of task variations with a representative example as implemented in a system for obtaining an evaluation of a quality of software code that is generated by using an LLM, according to an exemplary embodiment. Referring to FIG. 6, each task within the evaluation dataset is designed with a tiered structure, offering an original version along with easy, medium, and hard variations. The easy version provides clarity by explicitly including the API response field in the task instructions, ensuring straightforward code generation. In contrast, the medium version introduces a nuanced approach, providing a subtle hint to guide in solving the task. The hard version, intentionally implicit, challenges the proposed skill distillation agent with a higher level of complexity.

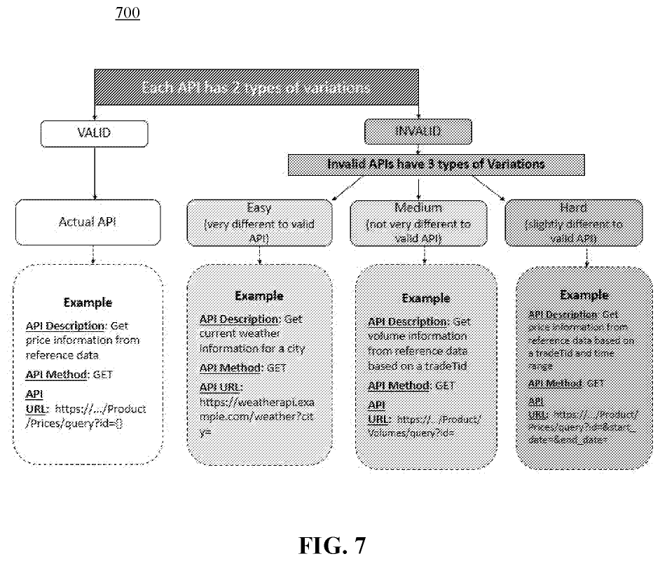

FIG. 7 is an illustration 700 of types of application programming interface (API) variations with a representative example as implemented in a system for obtaining an evaluation of a quality of software code that is generated by using an LLM, according to an exemplary embodiment. Referring to FIG. 7, along with variations in tasks, variations in the availability of the APIs are also introduced for comprehensive assessment of the skill distillation agent's task solving capabilities. For each task, a set of available APIs is incorporated. This API set comprises a valid (i.e., actual) API, which serves as the correct API for the given task. Additionally, additional APIs have been introduced across different variation levels. The easy API version presents an intentionally irrelevant API that is unrelated to the task at hand. The medium API version introduces a subtly related API, providing a challenge to identify the API that is somewhat connected to both the task and the valid API. The hard version presents an API with only subtle differences from the valid API. This level of intricacy demands attention to API details and a deeper understanding of the task requirements. These API variations enhance the complexity and depth of the evaluation tasks, offering a spectrum of challenges for the proposed methodology such as correct API identification and response interpretation.

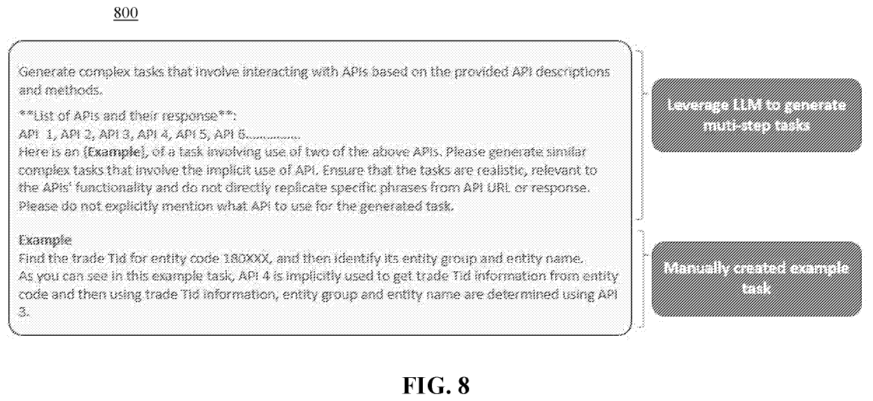

FIG. 8 is an illustration 800 of a prompt for an API-based multi-step task generation operation as implemented in a system for obtaining an evaluation of a quality of software code that is generated by using an LLM, according to an exemplary embodiment. The following is a summary of a process of evaluation dataset generation. Throughout the evaluation data generation phase, a combination of manual and automatic generation techniques has been utilized to ensure both precision and scalability. Referring to FIG. 8, to provide an illustration, an example of API-based multi-step task generation is shown. This example demonstrates how an LLM is leveraged to generate additional tasks based on a manually generated task provided as an example in the prompt. This leveraging LLM-based approach is employed to create the task instruction and API variations discussed above. The evaluation dataset reflects the flexibility and adaptability required to address the challenges in achieving successful automation of real-world tasks that include multi-step instructions, ensuring that the evaluation dataset assesses the true potential of the proposed LLM-based code generation methodology.

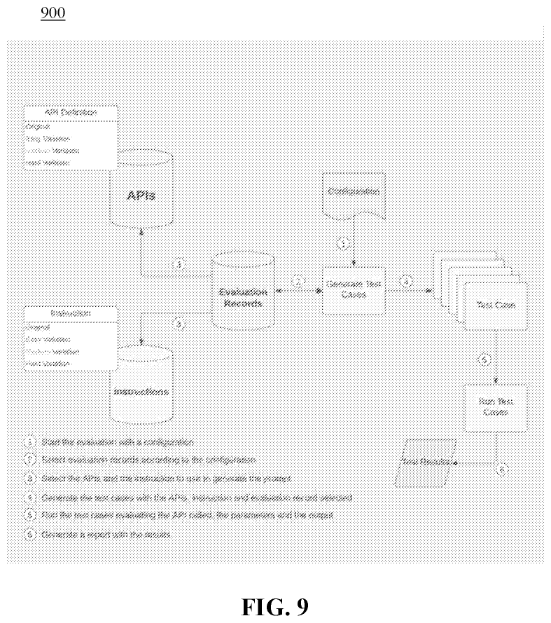

FIG. 9 is an illustration 900 of an evaluation pipeline as implemented in a system for obtaining an evaluation of a quality of software code that is generated by using an LLM, according to an exemplary embodiment.

Evaluation Configuration: In an exemplary embodiment, the configuration drives the types of tests one wants to run. The configuration includes: 1) the difficulty level of the instruction to use in the prompt; 2) the difficulty level and number of extra APIs to include in the prompt; 3) the categories of test to select from the evaluation records dataset; and 4) the number of runs to execute to evaluate the consistency of the response.

In an exemplary embodiment, the configuration is used to construct the test cases. A test case is composed of an instruction, a set of APIs, a list of expected API calls with their input parameters, and an expected output. The instruction and the APIs are selected from the instructions dataset and the APIs dataset according to the level of complexity defined in the configuration.

For each of the cases, the skill distillation agent is queried with a prompt generated with the present inventive methodology, and generates the code to solve the given task. The code is then executed by the execution agent. It is at execution that any call to an API is captured and the set of parameters used is evaluated. The final output is then retrieved and compared with the expected output defined in the evaluation records dataset. Any exception raised during this process is captured for reporting. To avoid calling the real APIs and ensure reproducibility of the test results, all the calls to the APIs are mocked and previously captured data is returned.

The results for each test case are processed to understand for each test case whether the code could run without any exception, whether the correct API was selected, whether the correct input parameters were passed and whether the output generated was correct. The results are aggregated, and a summary report is generated. The results are first aggregated by test case across the multiple runs, and the mean is determined for each metric including a first metric relating to executability, a second metric relating to whether a correct API is selected, a third metric relating to the correctness of the inputs, and a fourth metric relating to the correctness of the output. Finally, the mean value of the results over the full evaluation dataset is reported.

Accordingly, with this technology, an effective process for obtaining an evaluation of a quality of software code that is generated by using an LLM is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for evaluating code quality, the method being implemented by at least one processor, the method comprising:
receiving, by the at least one processor, a first set of instructions for performing a first task and generating a first output;
providing, by the at least one processor as an input to a first large language model (LLM), a list of available application programming interfaces (APIs) and the first set of instructions, together with a submission of a request to the first LLM to select one API and to generate a first set of executable code based on the first set of instructions;
receiving, by the at least one processor from the first LLM, a selection of the one API and the first set of executable code;
executing, by the at least one processor, the first set of executable code in order to perform the first task and generate the first output; and
evaluating, by the at least one processor, a quality of the first set of executable code.

2. The method of claim 1, wherein the evaluating of the quality of the first set of executable code comprises evaluating at least one from among an accuracy of the first set of executable code, a robustness of the first set of executable code, and a consistency of the first set of executable code.

3. The method of claim 2, wherein the evaluating of the accuracy of the first set of executable code comprises:
checking whether the first set of executable code runs;
checking whether the first set of executable code calls a correct API with correct parameters; and
checking whether the first output matches with an expected output.

4. The method of claim 2, wherein the evaluating of the robustness of the first set of executable code comprises:
determining a difficulty level of the first set of instructions; and
assessing the selection of the one API and an ability to execute the first set of instructions based on the determined difficulty level.

5. The method of claim 4, wherein the determining of the difficulty level comprises determining a degree of implicitness of information included in the first set of instructions with respect to the first task.

6. The method of claim 2, wherein the evaluating of the consistency of the first set of executable code comprises:
testing results of the executing of the first set of executable code across multiple runs; and
determining whether the results provide different answers for a same input.

7. The method of claim 6, wherein the testing of the results is performed for at least three runs and for at most ten runs.

8. The method of claim 2, wherein the evaluating of the quality of the first set of executable code is performed by using an evaluation dataset that is API-based.

9. A computing apparatus for evaluating code quality, the computing apparatus comprising:
a processor;
a memory; and
a communication interface coupled to each of the processor and the memory,
wherein the processor is configured to:
receive, via the communication interface, a first set of instructions for performing a first task and generating a first output;
provide, as an input to a first large language model (LLM), a list of available application programming interfaces (APIs) and the first set of instructions, together with a submission of a request to the first LLM to select one API and to generate a first set of executable code based on the first set of instructions;
receive, from the first LLM, a selection of the one API and the first set of executable code;
execute the first set of executable code in order to perform the first task and generate the first output; and
evaluate a quality of the first set of executable code.

10. The computing apparatus of claim 9, wherein the processor is further configured to evaluate the quality of the first set of executable code by performing at least one from among an evaluation of an accuracy of the first set of executable code, an evaluation of a robustness of the first set of executable code, and an evaluation of a consistency of the first set of executable code.

11. The computing apparatus of claim 10, wherein the processor is further configured to perform the evaluation of the accuracy of the first set of executable code by:
checking whether the first set of executable code runs;
checking whether the first set of executable code calls a correct API with correct parameters; and
checking whether the first output matches with an expected output.

12. The computing apparatus of claim 10, wherein the processor is further configured to perform the evaluation of the robustness of the first set of executable code by:
determining a difficulty level of the first set of instructions; and
assessing the selection of the one API and an ability to execute the first set of instructions based on the determined difficulty level.

13. The computing apparatus of claim 12, wherein the processor is further configured to make the determination of the difficulty level by determining a degree of implicitness of information included in the first instruction with respect to the first task.

14. The computing apparatus of claim 10, wherein the processor is further configured to perform the evaluation of the consistency of the first set of executable code by:
testing results of the executing of the first set of executable code across multiple runs; and
determining whether the results provide different answers for a same input.

15. The computing apparatus of claim 14, wherein the testing of the results is performed for at least three runs and for at most ten runs.

16. The computing apparatus of claim 10, wherein the processor is further configured to evaluate the quality of the first set of executable code by using an evaluation dataset that is API-based.

17. A non-transitory computer readable storage medium storing instructions for evaluating code quality, the storage medium comprising a first set of executable code which, when executed by a processor, causes the processor to:
receive a first set of instructions for performing a first task and generating a first output;
provide, as an input to a first large language model (LLM), a list of available application programming interfaces (APIs) and the first set of instructions, together with a submission of a request to the first LLM to select one API and to generate a second set of executable code based on the first set of instructions;
receive, from the first LLM, a selection of the one API and the second set of executable code;
execute the second set of executable code in order to perform the first task and generate the first output; and
evaluate a quality of the second set of executable code.

18. The storage medium of claim 17, wherein when executed by the processor, the first set of executable code further causes the processor to evaluate the quality of the second set of executable code by evaluating at least one from among an accuracy of the second set of executable code, a robustness of the second set of executable code, and a consistency of the second set of executable code.
